(19) United States
(12) Patent Application Publication
(10) Pub. No.: US 2023/0397632 A1
(43) Pub. Date: Dec. 14, 2023

(54) METHOD FOR PRODUCING A BEVERAGE

(71) Applicant: Starbucks Corporation, Seattle, WA (US)

(72) Inventors: Elizabeth Guilherme, Seattle, WA (US); Kieran Murphy, Seattle, WA (US); Francisco Eladio Gomez Zapata, Medellin (CO); Samuel Kazes, Medellin (CO)

(21) Appl. No.: 18/334,002

(22) Filed: Jun. 13, 2023

Related U.S. Application Data
(60) Provisional application No. 63/366,355, filed on Jun. 14, 2022.

(51) Int. Cl. A23F 5/30; A23F 5/18; A23F 5/34; A23F 5/04; A23F 5/26; B01D 61/02; B01D 61/08

(52) U.S. Cl. CPC A23F 5/30; A23F 5/18; A23F 5/34; A23F 5/04; A23F 5/26; B01D 61/025; B01D 61/08; B01D 2311/02

(57) ABSTRACT

Various beverage preparation methods are disclosed. The beverage preparation method can include purifying a first portion of an extract with reverse osmosis. The method can further include concentrating a second portion of an extract with freeze concentration, the first portion of the extract being separate from the second portion of the extract. The method can further include spray drying the first portion of the extract and the second portion of the extract to produce dried particles. The ratio of the first portion of the extract and the second portion of the extract can be at least 3:1.

### CROSS-REFERENCE TO RELATED APPLICATION(S)

This application claims the benefit of U.S. Provisional Application No. 63/366,355, filed on Jun. 14, 2022, which is hereby incorporated by reference herein in its entirety.

### BACKGROUND

### Field

The present disclosure relates to systems and methods for preparing beverages, such as, in certain embodiments, systems and methods for preparing a beverage using reverse osmosis and freeze concentration.

### DESCRIPTION OF CERTAIN RELATED ART

The process of preparing a beverage can include roasting coffee beans or grounds, extracting coffee (such as hot brew or cold brew) from the coffee grounds, and treating the extract. The extract can, in turn, be concentrated.

### SUMMARY

The systems, methods and devices of this disclosure each have several innovative aspects, no single one of which is solely responsible for the desirable attributes disclosed herein.

An extract can be treated with filtering and/or concentrating the extract, such as to purify the extract by removing sediment and/or solids. The process of reverse osmosis can be applied to concentrate the extract. The process of freeze concentration can be applied to concentrate the extract. These processes can be used to create hot brewed soluble coffee, cold brew soluble coffee, soluble coffee that has been thermally concentrated, or freeze dried coffee. These soluble or freeze dried coffees can then be reconstituted to produce shelf stable beverages. Processing can often dilute or thin the final beverage. It can be challenging to maintain the body and flavor of the beverage produced, while also minimizing sediment.

In one aspect, a method of producing a beverage can include purifying a first portion of an extract with reverse osmosis and concentrating a second portion of an extract with freeze concentration. The second portion of the extract can be separate from the first portion of the extract. The method can further include spray drying the first portion of the extract and the second portion of the extract to produce dried particles. The ratio of the first portion of the extract and the second portion of the extract is at least 3:1.

In some configurations, the first portion of the extract can not be subjected to freeze concentration. The second portion of the extract can not be subjected to reverse osmosis. The ratio of the first portion of the extract and the second portion of the extract can be at least 4:1. The ratio of the first portion of the extract and the second portion of the extract can be at least 9:1. The method can further include combining the first portion of the extract and the second portion of the extract prior to spray drying. Spray drying can include spray drying the first portion of the extract separately from the second portion of the extract to produce a first portion of dried particles and spray drying the second portion of the extraction separately from the first portion of the extract to produce a second portion of dried particles. The method can further include combining the first portion of dried particles and the second portion of dried particles after spray drying. The extract can include cold brew coffee. The extract can include hot brew coffee. The method can further include roasting an extraction material. The method can further include introducing an extraction medium into the extraction material to extract an extract from the extraction material. In some configurations, the extraction medium can include water. The extraction medium can be at a temperature between 15° C. and 30° C. The extraction medium can be at a temperature below 30° C., The method can further include reconstituting the dried particles to produce a beverage. The dried particles can be reconstituted with water. In some configurations, purifying the first portion of the extract with reverse osmosis can include purifying the first portion into a thin liquor having a concentration between 20 Bx to 40 Bx. In some configurations, concentrating the second portion of the extract with freeze concentration can include concentrating the second portion of the extract to a concentration between 35 Bx to 45 Bx.

In another aspect, a system for producing a beverage can include a brewer configured to receive an extraction material and a flow of extraction medium to produce an extract. The system can also include a reverse osmosis system configured to receive a first portion of the extract. The system can further include a freeze concentration system configured to receive a second portion of the extract, the second portion of the extract separate from the first portion of the extract. The system can also include a spray drying chamber configured to receive the first portion of the extract and/or the second portion of the extract to produce spray dried particles. The ratio of the first portion of the extract and the second portion of the extract can be at least 3:1. The system can also includes a reconstitution system for receiving the first portion of the extract and/or the second portion of the extract.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1 depicts an example flow chart embodying methods for producing a beverage.

FIG. 2 is a schematic system of an embodiment for a system producing a beverage.

FIG. 3 depicts another example flow chart embodying methods for producing a beverage.

### DETAILED DESCRIPTION OF CERTAIN EMBODIMENTS

Many of the embodiments described herein involve extracting coffee beans (e.g., roasted coffee or espresso beans) to yield an extract, such as coffee extract, such as cold brew or hot brew coffee. For instance, in some embodiments, the material to be extracted also referred to herein as the “extraction material” may be coffee beverage such as espresso or coffee. The coffee beans can be any variety or species from any part of the world. For example, Arabica, Robusta, and any blend of Arabica and Robusta from any part of the world (such as Brazil, Indonesia, Central America, Africa, etc.). In some embodiments, the extraction material may be an edible substance and may also be, in whole or in part, at least one of green coffee cherries, red coffee cherries, coffee flowers, coffee cherry pulp, coffee cherry stalk, coffee cherry exocarp, or coffee cherry mesocarp. However, it should be appreciated that certain features and aspects of the embodiments disclosed herein may be applicable to other beverages besides coffee extracts, such as teas and other similar infusions and/juices. For example, in yet other embodiments, the extraction material may be green tea leaves and/or partially or totally dehydrated tea leaves. In still further embodiments, the extraction material may comprise fruits, nuts, or similar plant matter including vanilla beans, chocolate beans, hazelnuts, almond, macadamia, peanut, cinnamon, mint, apple, apricot, aromatic bitters, banana, blackberry, blueberry, celery, cherry, cranberry, strawberry, raspberry, juniper berry, brandy, cachaca, carrot, citrus, lemon, lime, orange, grapefruit, tangerine, coconut, menthol, ginger, licorice, milk, pecan, pistachio, walnut, peach, pear, pepper, among others. Thus, the description herein is not limited to espresso, coffee, coffee products, tea or tea products.

Certain implementations of the systems, methods, and compounds described herein refer to extract in the form of hot or cold brew extracts. In certain configurations, extracts may be coffee extracts, tea extracts, juices and herbal extracts, among others. Moreover, this term hot brew extract is applied broadly to refer to extracts prepared with the use of an extraction medium exceeding 100° C. Likewise, certain implementations of the systems, methods, and compounds described herein refer to extract in the form of cold brew extracts. Moreover, this term cold brew extract is applied broadly to refer to extracts prepared with the use of an extraction medium not exceeding 100° C. For instance, in certain configurations described herein, the extraction medium may be between 0° C. and 100° C. In certain embodiments, the temperature of the extraction medium may be between 10° C. and 30° C. and in certain embodiments between 15° C. and 30° C. and in certain embodiments between 15° C. and 30° C. In certain implementations, the extraction medium can be a liquid such as water but in certain implementations the extraction medium can be other liquids. In certain implementations, the extraction medium is at ambient temperatures when added to the extraction cell as described below and/or added to the extraction cell without heating or otherwise actively changing the temperature of the extraction medium (e.g., water) from its source. In certain embodiments, the extraction medium is at a temperature that exceeds 100° C.

Likewise, certain implementations of the systems, methods, and compounds described herein refer to certain processes as reverse osmosis. This term reverse osmosis is applied broadly to refer to processes applied to purify an extract using a partially permeable membrane and applied pressure, in particular to remove sediment or solids.

Likewise, certain implementations of the systems, methods, and compounds described herein refer to certain processes as freeze concentration. This term freeze concentration is applied broadly to refer to processes applied to concentrate an extract by freezing the water content of the extract and removing the crystals formed from freezing. The temperature used during freeze concentration is below 0° C., and in some examples the range of between −2 and −10° C.

Likewise, certain implementations of the systems, methods, and compounds described herein refer to certain processes as spray drying. This term spray drying is applied broadly to refer to processes applied to produce particles, such as dried particles or soluble material (e.g. soluble coffee) from drying an extract (which may be concentrated and/or purified prior to drying). Spray drying may include atomizing or spraying an extract. Spray drying can also include applying high heat to evaporate moisture and form dry particles.

Likewise, certain implementations of the systems, methods, and compounds described herein refer to certain processes as freeze drying. This term freeze drying is applied broadly to refer to processes applied to produce particles, such as dried particles or soluble material (e.g., soluble coffee) from drying an extract (which may be concentrated and/or purified prior to drying) using freezing. Freeze drying can include lowering a temperature of an extract below a threshold temperature to induce sublimation and removing ice crystals formed with sublimation. Freeze drying can also include applying low pressure to an extract. Freeze drying can advantageously lead to dried particles or soluble material that is never heated, which may eliminate many off notes.

Various beverage preparation systems and methods are described below to illustrate various examples that may achieve one or more desired improvements. These examples are only illustrative and not intended in any way to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown, but is instead to be accorded the widest scope consistent with the principles and features that are disclosed or suggested herein. In many of the embodiments described herein, the beverage preparation system is described as creating hot brewed soluble coffee, cold brew soluble coffee, soluble coffee that has been thermally concentrated, or freeze dried coffee. These soluble or freeze dried coffees can then be reconstituted to produce shelf stable beverages. However, it should be appreciated that certain features and aspects of the embodiments disclosed herein may be applicable to other beverages besides coffee product and thus the description herein is not limited to coffee products.

Although certain aspects, advantages, and features are described herein, it is not necessary that any particular embodiment include or achieve any or all of those aspects, advantages, and features. Some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable.

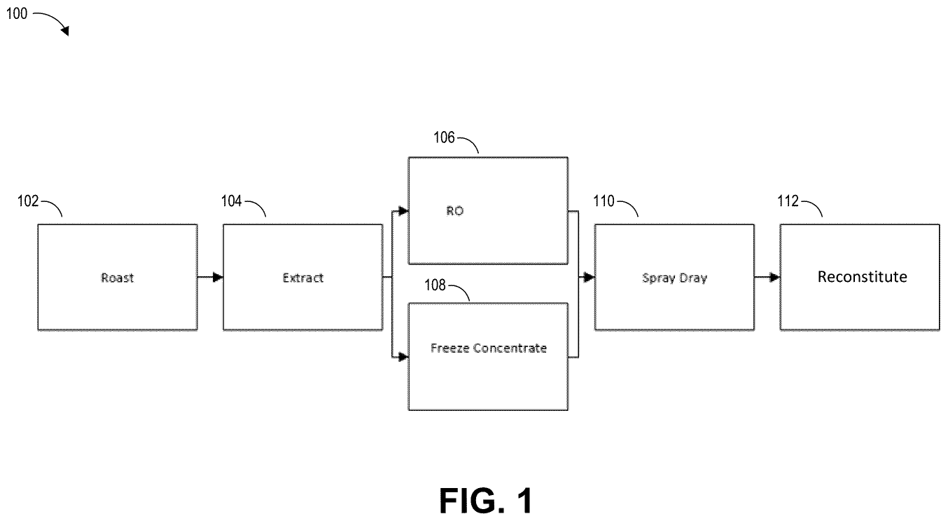

FIG. 1 illustrates an example method 100 related to various beverage preparation systems. As shown, in some embodiments, the method 100 can begin at block 102 with roasting or otherwise treating an extraction material, which can be coffee beans in one example embodiment. At block 104, the treated extraction material can then be extracted with an extraction medium, such as water. The extraction medium may be hot, ambient, or cold in temperature.

As noted above, “hot” can refer to extracts prepared with the use of an extraction medium exceeding 100° C. “Cold” is applied broadly to refer to extracts prepared with the use of an extraction medium not exceeding 100° C. For instance, in certain configurations described herein, the extraction medium may be between 0° C. and 100° C. In certain embodiments, the temperature of the extraction medium may be between 10° C. and 30° C. and in certain embodiments between 15° C. and 30° C. and in certain embodiments between 15° C. and 30° C. In certain implementations, the extraction medium can be a liquid such as water but in certain implementations the extraction medium can be other liquids. In certain implementations, the extraction medium is at ambient temperatures when added to the extraction cell as described below and/or added to the extraction cell without heating or otherwise actively changing the temperature of the extraction medium (e.g., water) from its source.

At block 106, a portion of the extract, such as a first portion, produced at block 104 can be treated with reverse osmosis to purify the portion of the extract to remove any solids or sediments using a partially permeable membrane and applied pressure. After being treated with reverse osmosis, the extract can be purified into a thin or thick liquor. In some examples, the thin liquor can have a concentration between 20 to 30 Bx, and in some embodiments a concentration of 25 Bx.

At block 108, a portion of the extract, such as a second portion, produced at block 104 can be treated with freeze concentration to concentrate the portion of the extract by freezing the water content of the extract and removing the crystals formed from freezing. After freeze concentration, the extract can have a concentration between 35 to 45 Bx, and in some embodiments, a concentration of 40 Bx.

As illustrated, the blocks 104 and 106 of the method 100 can occur at substantially the same time. In some examples, the blocks 104 and 106 can occur sequentially in any order. The first portion of extract treated at block 106 with reverse osmosis is not treated with freeze concentration. Similarly, the second portion of extract treated at block 108 with freeze concentration is not treated with reverse osmosis. In some examples, 50% to 90%, 60% to 90%, 70% to 90%, or 80% to 90% of the extract is treated with reverse osmosis. In some examples, 50% to 10%, 40% to 10%, 30% to 10%, or 20% to 10% of the extract is treated with freeze concentration. In some examples, the ratio of the first portion treated with reverse osmosis to the second portion treated with freeze concentration is at least 1:1. In some examples, the ratio is at least 2:1, 3:1, 4:1, 5:1, 6:1, 7:1, 8:1, or 9:1.

Thus, the method can incorporate a ratio of the first portion treated with reverse osmosis (such as 80% to 90%) and the second portion treated with freeze concentration (such as 10% to 20%).

At block 110, the first portion of the extract treated with reverse osmosis at block 106 and the second portion of the extract treated with freeze concentration at block 108 can be spray dried to produce particles from the extract. The particles produced can be dried particles or soluble material (e.g., soluble coffee) from drying the extract. Spray drying may include atomizing or spraying an extract. Spray drying can also include applying high heat to evaporate moisture and form dry particles. In some examples, the first portion of the extract treated with reverse osmosis at block 106 and the second portion of the extract treated with freeze concentration at block 108 can be initially combined before being spray dried at block 110. In some examples, the first portion of the extract treated with reverse osmosis at block 106 and the second portion of the extract treated with freeze concentration at block 108 can each separately be spray dried at block 110. The dried particles produced from each of the first and second portions can then be combined after the spray drying process. For example, the first portion of the extract can be spray dried separately from the second portion of the extract to produce a first portion of dried particles. The second portion of the extract can be spray dried separately from the first portion of the extract to produce a second portion of dried particles. The first portion of dried particles and the second portion of dried particles can then be combined after spray drying.

At block 112, the spray dried particles produced can be then reconstituted with a reconstitution medium to produce a beverage or a portion of a beverage. In some examples, the reconstitution medium can be water. In some examples, reconstitution can occur at a different location or the same location as any of the previous steps, such as the same location as the spray drying at block 110. This would advantageously reduce shipping costs by shipping the spray dried particles. For example, after spray drying at block 110, the spray dried particles can then be packaged and shipped to another location and subsequently reconstituted at a later time.

As previously described, the first portion of the extract treated with reverse osmosis at block 106 and the second portion of the extract treated with freeze concentration at block 108 can each combined at a desired ratio and then spray dried at block 110. The spray dried particles can then be packaged and shipped to another location for reconstitution.

As previously described, the first portion of the extract treated with reverse osmosis at block 106 and the second portion of the extract treated with freeze concentration at block 108 can each separately be spray dried at block 110. In some examples, these portions of dried particles produced can be separately packaged and separately shipped. These separate packages can then be combined at desired ratios at a secondary location before reconstitution. In some examples, these portions can be combined after spray drying at block 110 at the desired ratio and packaged together before shipping to another location for reconstitution. In some examples, the spray dried particles can be combined at a desired ratio in a container to be used for reconstitution. In some examples, the spray dried particles can be combined at a desired ratio at a different location shortly before reconstitution.

By using a ratio of reverse osmosis and freeze concentration as described in this method, the body and flavor of the beverage can be maintained, while minimizing sediment in the beverage.

In some examples, the process may include thermal processing to sterilize the extract or the dried particles produced, such as with ultra-heat treatment or sterilization.

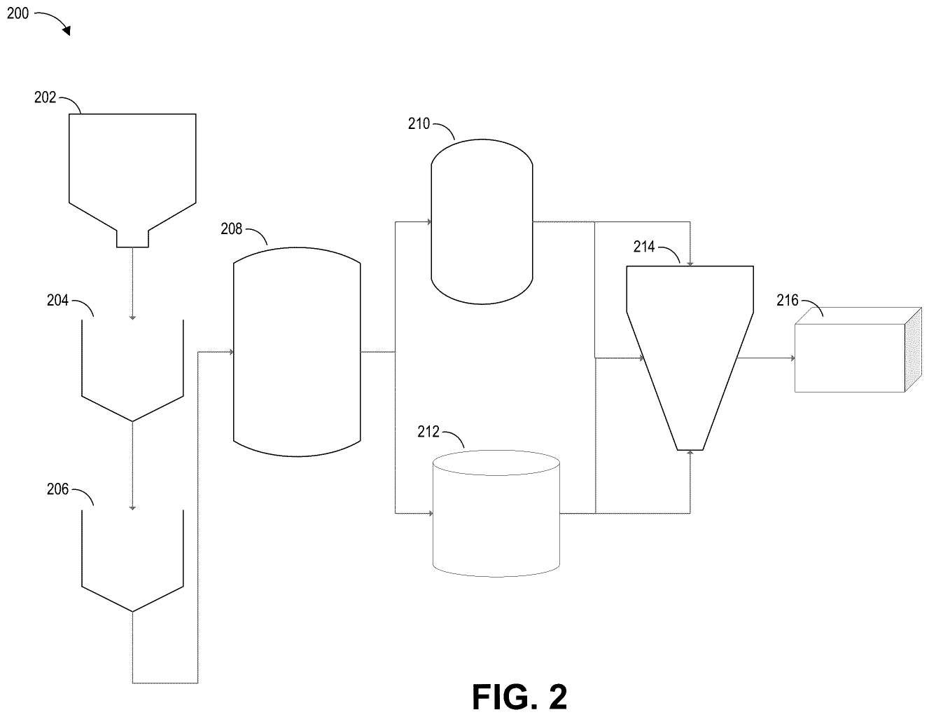

FIG. 2 is a schematic system of an embodiment for a system producing a beverage. The system 200 can be used to produce cold brew or hot brew beverages. To facilitate presentation, the system 200 is frequently described in the context of an extraction material in the form of tea leaves or ground coffee beans, to brew an extract that is a tea or coffee extract with an extraction medium that is water. However, as noted above, certain features and aspects of the present disclosure can be applied in other contexts as well.

The system 200 can include at least one source of extraction medium. As shown in FIG. 2, the source of extraction medium can include a whole bean coffee hopper 202. The whole bean coffee hopper 202 can then feed whole beans to a treatment device such as a roaster 204, which can roast the whole beans. The roaster 204 can then feed roasted beans to a grinder 206, which can grind the beans and produce ground coffee. The grinder 206 can be fed into a brewer 208 to fill the brewer 208 with ground coffee. In other examples, a pre-ground coffee hopper, which contains pre-ground roasted coffee grounds, can alternatively or additionally be present. The pre-ground coffee hopper can also fill the brewer 208 with ground coffee. When the brewer 208 is filled with the extraction material (e.g., the ground coffee), the brewer 208 can also be filled with extraction medium (e.g., water). In some examples, the extraction medium can be cold or ambient in temperature, such as between 0° C. and 100° C., between 15° C. and 30° C., or below 30° C. In other examples, the extraction medium can be hot in temperature, such as above 30° C. or above 100° C. In the brewer 208, the extraction medium passes through the extraction material. The extraction medium can extract desirable compounds of the extraction material and pulls the compounds into the extraction medium and dissolves it to form an extract. The extract formed in the brewer 208 can then be dispensed outside the brewer 208.

In some examples, extraction medium can be flowed upward through the brewer 208 and the extraction material positioned within the brewer 208. In some examples, extraction medium can be flowed downward or sideways into the brewer 208. In some examples, the flow of extraction medium can be continuous. In some examples, extraction medium can be introduced into the brewer 208 and then remain in the brewer 208 with the extraction material for a period of time for steeping.

The extract can then be divided into at least two portions, a first portion can be directed to a reverse osmosis system 210 and a second portion can be directed to a freeze concentration system 212. The first portion can be treated in the reverse osmosis system 210 to purify the first portion of the extract by removing any solids or sediments using a partially permeable membrane and applied pressure. The second portion can be treated in the freeze concentration system 212 to concentrate the second portion of the extract by freezing the water content of the second portion of the extract and removing the crystals formed from the freezing.

In some examples, the first portion and the second portion can each be treated at substantially the same time in the reverse osmosis system 210 and the freeze concentration system 212, respectively. In some examples, the first portion and the second portion can occur sequentially in any order in the separate systems. The first portion of extract treated in the reverse osmosis system 210 is not also treated with freeze concentration. Similarly, the second portion of extract treated in the freeze concentration system 212 is not also treated with reverse osmosis. In some examples, the first portion treated with reverse osmosis is 50% to 90%, 60% to 90%, 70% to 90%, or 80% to 90% of the extract. In some examples, the second portion treated with freeze concentration is 50% to 10%, 40% to 10%, 30% to 10%, or 20% to 10% of the extract. Thus, the system can incorporate a ratio of the extract treated the reverse osmosis system 210 (such as 80% to 90%) and treated with a freeze concentration system 212 (such as 10% to 20%). In some examples, the ratio of the first portion treated with reverse osmosis to the second portion treated with freeze concentration is at least 1:1. In some examples, the ratio is at least 2:1, 3:1, 4:1, 5:1, 6:1, 7:1, 8:1, or 9:1.

Each of the first portion of the extract treated in the reverse osmosis system 210 and the second portion of the extract treated in the freeze concentration system 212 can be fed to a spray drying chamber 214 to be spray dried to produce particles from the extract. The particles produced can be dried particles or soluble material (e.g., soluble coffee) from drying the extract. Spray drying may include atomizing or spraying the extract. Spray drying can also include applying high heat to evaporate moisture and form dry particles from the extract. In some examples, the first portion of the extract treated in the reverse osmosis system 210 and the second portion of the extract treated in the freeze concentration system 212 can be combined before being fed into the spray drying chamber 214 to be spray dried together. In some examples, the first portion of the extract treated in the reverse osmosis system 210 and the second portion of the extract treated in the freeze concentration system 212 can each be separately fed into the spray drying chamber 214 to be spray dried separately. The dried particles produced from each of the first and second portions can then be combined after being spray dried separately in the spray drying chamber 214.

After the spray drying chamber 214, whether combined before or after spray drying, the spray dried particles produced can be then fed into a reconstitution system 215, to be reconstituted with a reconstitution medium to produce a beverage or a portion of a beverage. In some examples, the reconstitution medium can be water. As previously described, reconstitution can occur at a different location or the same location as the other components of the system 200, such as the spray drying chamber 214. In some examples, the reconstitution system 215 is located in the same location as the spray drying chamber 214. In other examples, the reconstitution system 215 can be located at a different, secondary location. The spray dried particles produced in the spray drying chamber 214 can be packaged and shipped to this secondary location for reconstitution at a later time.

As previously described, the first portion of the extract treated in the reverse osmosis system 210 and the second portion of the extracted treated in the freeze concentration system 212 can each combined at a desired ratio and then spray dried in the spray drying chamber 214. The spray dried particles can then be packaged and shipped to another location for reconstitution.

As previously described, the first portion of the extract treated in the reverse osmosis system 210 and the second portion of the extracted treated in the freeze concentration system 212 can each separately be spray dried in the spray drying chamber 214. In some examples, the first portion and the second portion can each be separately packaged and separately shipped. These separate packages can then combined at specific ratios at a secondary location before being reconstituted in the reconstitution system 216. In some examples, the first portion and the second portion can be combined after spray drying in the spray drying chamber 214 at the desired ratio and packaged together before shipping to another location for reconstitution in the reconstitution system 216. In some examples, the spray dried particles of the first portion and the second portion can be combined at a desired ratio in a container to be used for reconstitution in the reconstitution system 216. In some examples, the spray dried particles of the first portion and the second portion can be combined at a desired ratio at a different location shortly before reconstitution in the reconstitution system 216.

By using a ratio of reverse osmosis and freeze concentration as described, the body and flavor of the beverage can be maintained, while minimizing sediment in the beverage.

In some examples, the system may also include a thermal processing system to sterilize the extract, such as with ultra-heat treatment or sterilization.

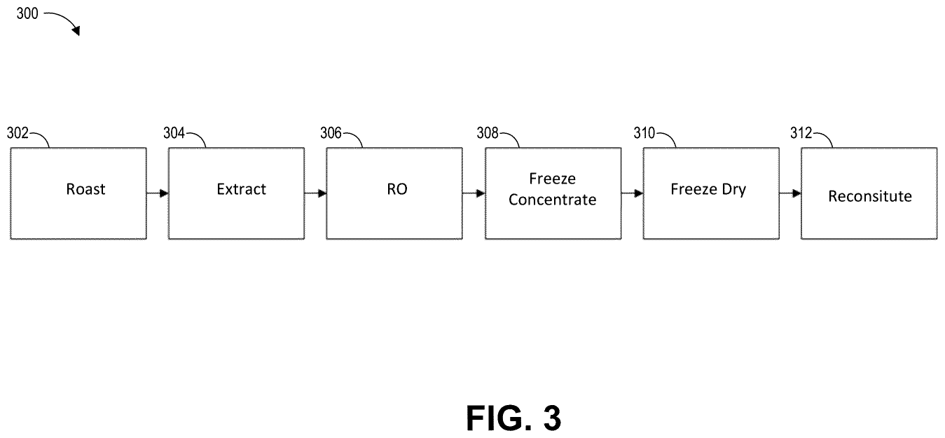

FIG. 3 illustrates yet another example method 300 related to various beverage preparation systems. As shown, in some embodiments, the method 300 can begin at block 302 with roasting an extraction material, which can be coffee beans. At block 304, the roasted extraction material can then be extracted with an extraction medium, such as water. The extraction medium may be hot, ambient, or cold in temperature.

At block 306, the extract produced at block 304 can be treated with reverse osmosis to purify the extract to remove any solids or sediments using a partially permeable membrane and applied pressure. After being treated with reverse osmosis, the extract can be purified into a thin or thick liquor. In some examples, the thin liquor can have a concentration between 20 to 30 Bx, and in some embodiments a concentration of 25 Bx.

At block 308, the extract treated at block 306 with reverse osmosis can then be treated with freeze concentration to concentrate the extract by freezing the water content of the extract and removing the crystals formed from freezing. After freeze concentration, the extract can have a concentration between 35 to 45 Bx, and in some embodiments, a concentration of 40 Bx.

As illustrated, the blocks 304 and 306 of the method 300 can occur at substantially sequentially in order, respectfully. The extract can first be treated by reverse osmosis and then freeze concentration, as shown. In some examples, the extract can first be treated with freeze concentration and then with reverse osmosis. In this manner, the extract treated at block 306 with reverse osmosis is also treated with freeze concentration at block 308, in either order.

At block 310, the extract that has been treated with reverse osmosis at block 304 and subsequently treated with freeze concentration at block 308 can then be freeze dried to produce particles from the extract. The process of freeze drying can produce dried particles or soluble material (e.g., soluble coffee) from drying an extract using freezing. Freeze drying can include lowering a temperature of an extract below a threshold temperature to induce sublimation and removing ice crystals formed with sublimation. Freeze drying can also include applying low pressure to an extract. Freeze drying can advantageously lead to a soluble that is never heated, which may eliminate many off notes that would otherwise be produced.

At block 312, the spray dried particles produced can be then reconstituted with a reconstitution medium to produce a beverage or a portion of a beverage. In some examples, the reconstitution medium can be water.

By using both reverse osmosis and freeze concentration as described in this method, the body and flavor of the beverage can be maintained, while minimizing sediment in the beverage.

In some examples, the process may include thermal processing to sterilize the extract, such as with ultra-heat treatment or sterilization.

### Certain Terminology

As used herein, the term “beverage” has its ordinary and customary meaning, and includes, among other things, any edible liquid or substantially liquid substance or product having a flowing quality (e.g., juices, coffee beverages, teas, frozen yogurt, beer, wine, cocktails, liqueurs, spirits, cider, soft drinks, flavored water, energy drinks, soups, broths, combinations of the same, or the like).

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The claims are not to be limited to the non-exclusive embodiments and examples that are illustrated and described in this disclosure, or that are discussed during the prosecution of the application.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and features are described herein. Not necessarily all such aspects, advantages, and features may be achieved in accordance with any particular embodiment. For example, some embodiments of any of the various disclosed systems include the container assembly and/or include pluralities of the container assembly; some embodiments do not include the container assembly. Those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale where appropriate, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage preparation systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. A method of producing a beverage, the method comprising:
purifying a first portion of an extract with reverse osmosis;
concentrating a second portion of the extract with freeze concentration, the second portion of the extract being separate from the first portion of the extract; and
spray drying the first portion of the extract and the second portion of the extract to produce dried particles,
wherein a ratio of the first portion of the extract and the second portion of the extract is at least 3:1.

2. The method of claim 1, wherein the first portion of the extract is not subject to freeze concentration.

3. The method of claim 1, wherein the second portion of the extract is not subject to reverse osmosis.

4. The method of claim 1, wherein the ratio of the first portion of the extract and the second portion of the extract is at least 4:1.

5. The method of claim 1, wherein the ratio of the first portion of the extract and the second portion of the extract is at least 9:1.

6. The method of claim 1, further comprising combining the first portion of the extract and the second portion of the extract prior to spray drying.

7. The method of claim 1, wherein spray drying comprises spray drying the first portion of the extract separately from the second portion of the extract to produce a first portion of dried particles and spray drying the second portion of the extract separately from the first portion of the extract to produce a second portion of dried particles.

8. The method of claim 7, further comprising combining the first portion of dried particles and the second portion of dried particles after spray drying.

9. The method of claim 1, wherein the extract comprises cold brew coffee.

10. The method of claim 1, wherein the extract comprises hot brew coffee.

11. The method of claim 1, further comprising roasting an extraction material.

12. The method of claim 11, further comprising introducing an extraction medium into the extraction material to extract the extract from the extraction material.

13. The method of claim 12, wherein the extraction medium comprises water.

14. The method of claim 12, wherein the extraction medium is at a temperature between 15′ C and 30° C.

15. The method of claim 12, wherein the extraction medium is at a temperature below 30° C.

16. The method of claim 1, further comprising reconstituting the dried particles to produce the beverage.

17. The method of claim 16, wherein the dried particles are reconstituted with water.

18. The method of claim 1, wherein purifying the first portion of the extract with reverse osmosis comprises purifying the first portion into a thin liquor having a concentration between 20 Bx to 40 Bx.

19. The method of claim 1, wherein concentrating the second portion of the extract with freeze concentration comprises concentrating the second portion of the extract to a concentration between 35 Bx to 45 Bx.

20. A system for producing a beverage, the system comprising:
a brewer configured to receive an extraction material and a flow of extraction medium to produce an extract;
a reverse osmosis system configured to receive a first portion of the extract;
a freeze concentration system configured to receive a second portion of the extract, the second portion of the extract separate from the first portion of the extract; and
a spray drying chamber configured to receive the first portion of the extract and/or the second portion of the extract to produce spray dried particles,
wherein a ratio of the first portion of the extract and the second portion of the extract is at least 3:1.

21. The system of claim 20, further comprising a reconstitution system for receiving the first portion of the extract and/or the second portion of the extract.
